(19) United States
(12) Patent Application Publication
(10) Pub. No.: US 2025/0307557 A1
(43) Pub. Date: Oct. 2, 2025

(54) METHOD FOR GENERATING RESPONSE MESSAGE USING GENERATIVE AI MODEL AND SYSTEM THEREFOR

(71) Applicant: SAMSUNG SDS CO., LTD., Seoul (KR)

(72) Inventors: Vera KIM, Seoul (KR); Luke CHOO, Seoul (KR); Shawn Sungeun KIM, Seoul (KR); So Young KIM, Seoul (KR); Seung Jin KIM, Seoul (KR); Ki Chul JUNG, Seoul (KR)

(73) Assignee: SAMSUNG SDS CO., LTD, Seoul (KR)

(21) Appl. No.: 19/066,987

(22) Filed: Feb. 28, 2025

(30) Foreign Application Priority Data
Apr. 1, 2024 (KR) 10-2024-0044188
Apr. 1, 2024 (KR) 10-2024-0044217
Oct. 11, 2024 (KR) 10-2024-0138312

(51) Int. Cl. G06F 40/30; G06N 3/0475

(52) U.S. Cl. CPC G06F 40/30; G06N 3/0475

(57) ABSTRACT

There is provided a method for generating a response message using a generative AI model, performed by a computing system. The method may include acquiring a first message with a first user as a recipient, automatically generating a first prompt for identifying an intention of the first message, and transmitting the first prompt to a generative artificial intelligence-based query service, receiving a first answer from the generative artificial intelligence-based query service, inquiring information related to the first answer in an internal database that includes first task-related information of the first user, automatically generating a second prompt for generating a response to the first message by using the inquired first task-related information and transmitting the second prompt to the generative artificial intelligence-based query service, and generating a response message to the first message by using a second answer received from the generative artificial intelligence-based query service.

### CROSS-REFERENCE TO RELATED APPLICATIONS

This application claims priority from Korean Patent Application No.10-2024-0044188 filed on Apr. 1, 2024, Korean Patent Application No. 10-2024-0044217 filed on Apr. 1, 2024 and Korean Patent Application No. 10-2024-0138312 filed on Oct. 11, 2024, in the Korean Intellectual Property Office and all the benefits accruing therefrom under 35 U.S.C. 119, the contents of which in its entirety are herein incorporated by references.

### BACKGROUND

### Technical Field

The present disclosure relates to a method for generating a response message using a generative AI model and a system therefor, and more particularly, to a method for generating a task-related message by transmitting a prompt related to task-related information to a generative AI model and a system therefor.

### Description of the Related Art

A generative AI model means an artificial neural network capable of generating a new text, image and voice based on given data. The generative AI model may be used to automatically generate various types of contents.

A chat-bot using a generative AI model may provide an interactive service to answer to a user's query or assist a task. Such a chat-bot is efficiently used in various fields such as customer support and information search.

However, the current generative AI model performs machine learning based on general data. Therefore, the chat-bot using the current generative AI model may lack accuracy related to a task requiring up-to-date information and a task requiring personal information. Therefore, it is required to provide a chat-bot using a generative AI model, which may assist a specific individual's task.

### PRIOR ART REFERENCE

### Patent Reference

(Patent Reference 0001) Korean Laid-Open Patent No. 10-2019-0154939 (published on May 29, 2019)

### BRIEF SUMMARY

An object of the present disclosure is to provide a method for automatically generating a response message to a message of a counterpart on behalf of a user who is absent.

Another object of the present disclosure is to provide a method for automatically summarizing a task-related content generated while a user is in an absent state and automatically displaying the summarized result when the user is in a connected state again.

Other object of the present disclosure is to provide a method for generating a response using AI without increasing fatigue of the response using AI.

The objects of the present disclosure are not limited to those mentioned above and additional objects of the present disclosure, which are not mentioned herein, will be clearly understood by those skilled in the art from the following description of the present disclosure.

According to an aspect of the present disclosure, there is provided a method for generating a response message using a generative AI model, performed by a computing system. The method may comprise acquiring a first message with a first user as a recipient, automatically generating a first prompt for identifying an intention of the first message and transmitting the first prompt to a generative artificial intelligence-based query service, receiving a first answer from the generative artificial intelligence-based query service in response to the transmission of the first prompt, inquiring information related to the first answer in an internal database that includes first task-related information of the first user, automatically generating a second prompt for generating a response to the first message by using the inquired first task-related information and transmitting the second prompt to the generative artificial intelligence-based query service, and generating a response message to the first message by using a second answer received from the generative artificial intelligence-based query service in response to the transmission of the second prompt.

In some embodiments, the generating the response message to the first message includes automatically generating a third prompt for generating the response message to the first message by using the second answer and second task-related information of the first user and transmitting the third prompt to the generative artificial intelligence-based query service, and generating the response message to the first message by using a third answer received from the generative artificial intelligence-based query service in response to the transmission of the third prompt.

In some embodiments, the method may further comprise determining an absent state of a messenger of the first user and providing the generated response message to a sender of the first message.

In some embodiments, the method may further comprise waiting for the first user to provide the response message to the first message for a preset time, and providing the generated response message to the first message to the sender of the first message when the first user does not provide the response message to the first message for the preset time.

In some embodiments, the method may further comprise additionally receiving a second message from the sender of the first message, generating a response message to the second message, and immediately providing the response message to the second message to the sender of the first message.

In some embodiments, the method may further comprise additionally receiving a second message from the sender of the first message, determining whether it is possible to generate a response message to the second message, and immediately providing a message, which indicates that it is not possible to generate the response message to the second message, to the sender of the first message when it is not possible to generate the response message to the second message.

In some embodiments, the method may further comprise sensing an input of the response message to the first message of the first user; and providing the generated response message to the sender of the first message when the input of the response message is not sensed.

In some embodiments, the method may further comprise sensing an input of the response message to the first message of the first user, and displaying a preview of the generated response message to the first user when the input of the response message is sensed.

According to another aspect of the present disclosure, there is provided a method for generating a response message using a generative AI model, performed by a computing system. The method may comprise

In some embodiments, determining an absent state of a messenger of a first user, acquiring a first task-related content related to the first user and generated after a time when the absent state of the first user is determined, automatically generating a fourth prompt for summarizing the acquired task-related content when the messenger of the first user is changed to a connected state, transmitting the fourth prompt to a generative artificial intelligence-based query service and generating a summarized missed message by using a fourth answer received from the generative artificial intelligence-based query service in response to the transmission of the fourth prompt.

In some embodiments, the method may further comprise receiving a feedback related to the summarized missed message from the first user, inquiring information related to the feedback in an internal database that includes a second task-related content of the first user, automatically generating a fifth prompt for generating an answer to the feedback by using the inquired second task-related content and transmitting the fifth prompt to the generative artificial intelligence-based query service, and generating a response message to the feedback by using a fifth answer received from the generative artificial intelligence-based query service in response to the transmission of the fifth prompt.

In some embodiments, the method may further comprise receiving a feedback related to the summarized missed message from the first user, inquiring information related to the feedback in an internal database that includes a second task-related content of the first user; and providing the first user with a link connected to the inquired second task-related content.

In some embodiments, the method may further comprise checking a priority for the first task-related content set in advance, and providing the first user with a summarized missed message for the task-related content of which priority has been checked.

According to still another aspect of the present disclosure, there is provided a. system for generating a response message using a generative AI model. The system may comprise a communication interface, a memory into which a computer program is loaded; and one or more processors in which the computer program is executed, wherein the computer program includes an operation of acquiring a first message with a first user as a recipient, an operation of automatically generating a first prompt for identifying an intention of the first message and transmitting the first prompt to a generative artificial intelligence-based query service, an operation of receiving a first answer from the generative artificial intelligence-based query service in response to the transmission of the first prompt, an operation of inquiring information related to the first answer in an internal database that includes first task-related information of the first user, an operation of automatically generating a second prompt for generating an answer to the first message by using the inquired first task-related information and transmitting the first prompt to the generative artificial intelligence-based query service; and an operation of generating a response message to the first message by using a second answer received from the generative artificial intelligence-based query service in response to the transmission of the second prompt.

In some embodiments, the computer program further includes an operation of automatically generating a third prompt for generating the response message to the first message by using the second answer and second task-related information of the first user and transmitting the third prompt to the generative artificial intelligence-based query service; and an operation of generating the response message to the first message by using a third answer received from the generative artificial intelligence-based query service in response to the transmission of the third prompt.

In some embodiments, the computer program further includes an operation of determining an absent state of a messenger of the first user, and an operation of providing the generated response message to the first message to a counterpart of the messenger.

In some embodiments, the computer program further includes an operation of waiting for the first user to provide the response message to the first message for a preset time; and an operation of providing the generated response message to the first message to a sender of the first message when the first user does not provide the response message to the first message for the preset time.

In some embodiments, the computer program further includes an operation of sensing an input of the response message to the first message of the first user, and providing the generated response message to a sender of the first message when the input of the response message is not sensed.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a schematic view illustrating an overall configuration of a system for generating a response message using a generative AI model according to one embodiment of the present disclosure;

FIG. 2 is an exemplary flow chart illustrating a method for generating a response message using a generative AI model according to one embodiment of the present disclosure;

FIG. 3 is an exemplary view illustrating an example related to the flow chart of FIG. 2;

FIG. 4 is a flow chart illustrating a detailed example of S700 of FIG. 2;

FIG. 5 is an exemplary view illustrating a situation of FIG. 4;

FIG. 6 is an exemplary flow chart illustrating a sequence of a method for generating a response message using a generative AI model according to one embodiment of the present disclosure;

FIG. 7 is an exemplary view illustrating a situation of FIG. 6;

FIG. 8 is an exemplary flow chart illustrating a sequence of a method for generating a response message using a generative AI model according to one embodiment of the present disclosure;

FIGS. 9 and 10 are exemplary views illustrating a situation of FIG. 8;

FIG. 11 is a flow chart illustrating a method for generating a response message using a generative AI model according to one embodiment of the present disclosure;

FIG. 12 is an exemplary view illustrating a situation of FIG. 11;

FIG. 13 is a flow chart illustrating a method for generating a summarized missed message using a generative AI model according to one embodiment of the present disclosure;

FIG. 14 is an exemplary view illustrating a situation of FIG. 13;

FIG. 15 is a flow chart illustrating a method for generating a summarized missed message using a generative AI model according to one embodiment of the present disclosure;

FIGS. 16 and 17 are exemplary views illustrating a situation of FIG. 15;

FIG. 18 is an exemplary view illustrating a method for generating a summarized missed message using a generative AI model according to one embodiment of the present disclosure; and

FIG. 19 is a block diagram illustrating a hardware configuration of a computing device 1000 for a method for generating a response message using a generative AI model according to one embodiment of the present disclosure.

### DETAILED DESCRIPTION OF THE DISCLOSURE

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

A user in the present disclosure means a person who uses a system for generating a response message using a generative AI model according to some embodiments of the present disclosure. The user may receive a message through an external system such as a messenger, a mail system, a video conference program, and productivity software, and may receive a response message generated by the system for generating a response message using a generative AI model according to some embodiments of the present disclosure. In addition, a sender in the present disclosure means a person who has transmitted a message transmitted by a user. The sender does not necessarily have to use an external network and may transmit the message even through an internal system such as an intranet messenger.

A generative artificial intelligence-based query service in the present disclosure means an artificial intelligence service capable of generating various data including text, image and voice based on an input prompt. This service serves to analyze user-provided inputs, and to generate and provide responses suitable for the inputs. Examples of the generative artificial intelligence-based query service include ChatGPT, Google Bard, and Microsoft Copilot. However, it should be noted that the generative artificial intelligence-based query service is not limited to these examples.

Providing a message in the present disclosure means that the message is displayed on an external system. For example, it may mean that the system for generating a response message provides the message to the sender when the sender is able to check the message generated by the system for generating a response message of the present disclosure on the messenger. It should be noted that providing a message may be performed not only by the system for generating a response message but also by users and senders.

The input of a message in the present disclosure means a state that a message is input to a portion that can be input by an external system before the message is provided. For example, it may be considered that the user has entered the message when the user is writing a message in an input window after seeing the sender's message on the messenger.

Hereinafter, some embodiments will be described in detail with reference to the accompanying drawings.

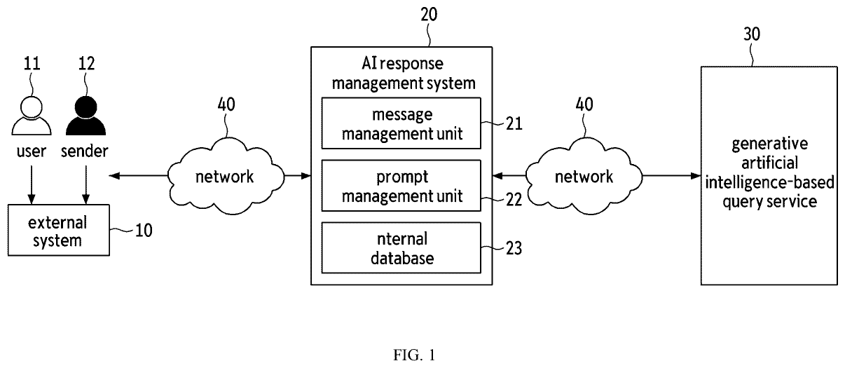

FIG. 1 is a schematic view illustrating an overall configuration of a system for generating a response message using a generative AI model according to one embodiment of the present disclosure. Hereinafter, the configuration and operation of the system for generating a response message using a generative AI model according to the present embodiment will be described with reference to FIG. 1.

As shown in FIG. 1, the system (hereinafter, referred to as a ‘response generating system’) for generating a response message using a generative AI model according to one embodiment of the present disclosure may include an external system 10, an AI response management system 20, a generative artificial intelligence-based query service 30, and a network 40.

The external system 10 in the present disclosure means an independent system distinguished from the AI response management system 20 of the present disclosure. In this case, the independent system may mean a system that functions independently without direct interaction with the AI response management system of the present disclosure. In addition, the independent system may mean a system having a function of processing and storing unique data, which is distinguished from the AI response management system of the present disclosure. For example, the external system may include a messenger, a mail system, a video conference program, and productivity software. The external system 10 may include all independent electronic systems regardless of whether they are connected to the Internet or an intranet. For example, the external system 10 may include an intranet messenger that may be used only in an intranet without being connected to the Internet. In addition, the external system 10 may include a plurality of independent systems. For example, the external system 10 may be a system that includes all of an intranet messenger, an intranet mail system and an intranet file drive.

Hereinafter, the operation of the external system 10 of the response generating system of the present disclosure will be described with reference to FIG. 1.

The external system 10 may acquire task-related contents including a message from a user 11 and a sender 12. For example, the external system 10 is a messenger, the user 11 and the sender 12 may transmit and receive task-related messages, which are task-related contents, through the messenger, and the messenger may acquire the transmitted and received messages.

In this case, the task-related contents mean all data necessary for performing a task between the user and the sender. For example, the task-related contents may include a task-related message, mail, document, video conference, and the like. The task-related contents mean unprocessed original files or data itself, and for example, the original mail, document file, video conference recording material and the like may be included in the task-related contents. On the other hand, task-related information is specific information extracted from the task-related contents, and may include, for example, specific data such as a meeting date, a document drafter, and a content of a specific agenda. That is, the task-related contents are the original material, and the task-related information may be information extracted or processed from the original material.

Also, the external system 10 may transmit the task-related contents, which include messages acquired from the user and the sender, to the AI response management system 20, and may receive a response message generated using the generative AI model generated by the AI response management system 20 and provide the response message to the user 11 or the sender 12.

Also, the external system 10 may check whether the state of the user 11 is an absent state or a connected state. In addition, the external system 10 may transmit information on the state of the user 11 to the AI response management system 20.

The absent state means a state that the user is displayed as not being connected to the external system. The absent state includes not only the case that the user is not actually connected to the external system but also the case that the user is displayed as not being connected to the external system in accordance with the user's intention. The user may be in the absent state by releasing the connection with the external system, and the absent state may be maintained for a time or period set by the user. In addition, when a preset condition is satisfied, the absent state may be automatically displayed regardless of whether the user is actually connected. For example, the absent state may be the case that the user terminates the messenger, the case that the user sets the messenger state to the absent state during a vacation period, or the case that the user is automatically changed to the absent state during the leaving-work time even though the user is still connected.

The connected state means the state that the user is displayed as being connected to the external system. The connected state may include the case that the user is displayed as being connected to the external system in accordance with the user's intention even though the user is not actually connected to the external system. For example, when the user is connected to the external system, the user may be in the connected state, and the connected state may be maintained for a time or period (e.g., working hours) set by the user. In addition, when a condition set in advance (e.g., the case that working is confirmed) is satisfied, the user may be displayed as the connected state regardless of whether the user has been actually connected. In addition, even though the user is not temporarily connected, the user may be in the connected state. The connected state is not limited only to whether the user is connected to the messenger, and may be determined using whether or not the user is connected to all external systems including a mail system or a video conference system.

Referring back to FIG. 1, the external system 10 may identify that the state of the user 11 is changed from the absent state to the connected state. Furthermore, the external system 10 may transmit information on the change in the state of the user 11 to the AI response management system 20.

In addition, the external system 10 may display the summarized missed message, which is provided from the AI response management system 20, to the user 11. In this case, the summarized missed message is a type of response message that can be generated by the response generating system, and means a message provided by summarizing the task-related contents acquired by the response generating system while the user's absent state continues. For example, the message “during the user's absence, one mail related to agenda A and one pending document and two messages related to agenda B have been received” may correspond to the summarized missed message. The summarized missed message is not limited to this example, but may include a more detailed summary.

In addition, the external system 10 may receive a feedback of the user 11 for the summarized missed message. Also, the external system 10 may transmit information related to the feedback of the user 11 for the summarized missed message to the AI response management system 20. The external system 10 may display a response message to the feedback, which is transmitted by the AI response management system 20, to the user 11. In this case, the feedback means a reaction of the user 11 to a message generated by the response generating system. The feedback may include not only a message input by the user but also an action such as clicking, tapping or touching the message generated by the response generating system.

The operation of the external system 10 is not limited to this example, and the operation of the external system 10 will be described in detail below.

Next, the AI response management system 20 means a system that generates a response message to be provided to the user 11 or the sender 12 by linking the external system 10 with a generative artificial intelligence-based query service 30. The AI response management system 20 may include at least one of a message management unit 21, a prompt management unit 22, or an internal database 23.

The message management unit 21 is a component responsible for an operation related to messages transmitted to and received from the external system 10. The message management unit 21 may transmit and receive messages to and from the external system 10, store the transmitted and received messages and request to generate a prompt related to the message. In this case, the prompt means data or query input to the generative artificial intelligence-based query service 30 to generate a response. The prompt includes information or content of a task, which is desired by the user, and an artificial intelligence model generates an appropriate response based on the prompt. For example, a prompt “let me know a meeting schedule for today” serves to allow artificial intelligence to inquire and answer the meeting schedule.

The prompt management unit 22 is a component responsible for an operation related to a prompt for acquiring an answer to the generative artificial intelligence-based query service 30. For example, the prompt management unit 22 may automatically generate a prompt for identifying an intention of a message acquired from the external system 10. Also, the prompt management unit 22 may automatically generate a prompt for generating a response message. Also, the prompt management unit 22 may automatically generate a prompt for customizing the response message. Also, the prompt management unit 22 may automatically generate a prompt for generating a summarized missed message. Also, the prompt management unit 22 may automatically generate a prompt for generating a response message to a feedback.

The internal database 23 means a database including only information and data related to a user and a user's task. The internal database may be a vector database in which data related to a user and the user's task is stored to be embedded, and may not be directly connected to the generative artificial intelligence-based query service. For example, the internal database may embed and store document, mail, minutes and message, which are related to the user's task.

The operation of the components of the AI response management system 20 is not limited to this example, and the operation of the components of the AI response management system 20 will be described in detail below.

The generative artificial intelligence-based query service 30 may generate an answer for generating a response message of the response generating system.

For example, the generative artificial intelligence-based query service 30 may generate an answer that interprets the intention of the message provided by the sender 12 by receiving a prompt from the AI response management system 20. Also, the generative artificial intelligence-based query service 30 may generate an answer for generating a response message to the message provided by the sender 12. Also, the generative artificial intelligence-based query service 30 may generate an answer for generating a response message to the message provided by the sender 12 based on task-related information of the user 11. Also, the generative artificial intelligence-based query service 30 may generate an answer for generating a summarized missed message. Also, the generative artificial intelligence-based query service 30 may generate an answer for generating a response message to a feedback of the summarized missed message.

The answers generated by the generative artificial intelligence-based query service 30 are not limited to the above examples, and the answer generated by the generative artificial intelligence-based query service 30 will be described in detail later through the following description.

Each component of the response generating system described above may perform communication through a network 40. For example, the network may be implemented as all kinds of wired/wireless networks such as a local area network (LAN), a wide area network (WAN), a mobile radio communication network and a wireless broadband Internet (Wibro).

The components of the response generating system according to some embodiments of the present disclosure have been described as above. In addition, the technical spirits that may be identified through some embodiments of the present disclosure, which will be described below, may be incorporated into the response generating system described above even though there is no separate description.

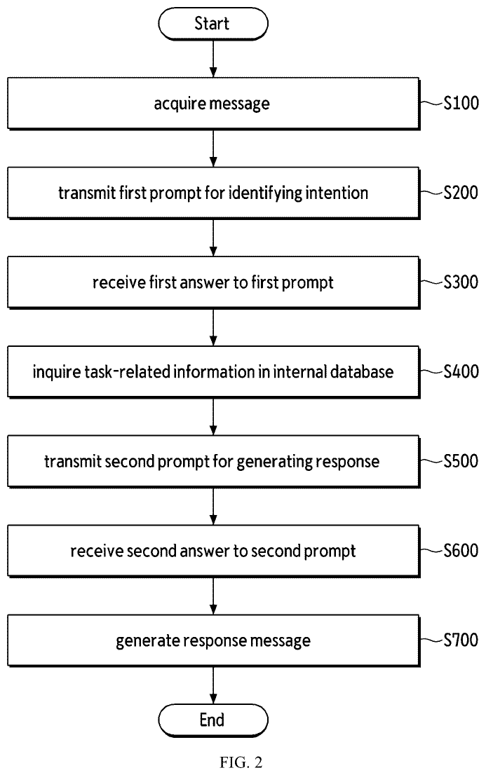

Hereinafter, a method (hereinafter, referred to as a ‘response generating method’) for generating a response message using a generative AI model according to some embodiments of the present disclosure will be described with reference to FIGS. 2 to 12.

The response generating method according to the present embodiment may be performed by one or more computing devices. For example, the response generating method may be generated by two or more computing devices. Some methods included in the response generating method may be performed by a first computing device, and other methods included in the response generating method may be performed by a second computing device. For example, the computing device may be the AI response management system described with reference to FIG. 1. In the following description, a subject of a specific step/operation may be omitted, and in this case, it may be understood that the step/operation is performed by the computing device.

Also, it is noted that the embodiments related to the response generating system described with reference to FIG. 1 may be applied to the response generating method according to the present embodiment even though there is no separate description.

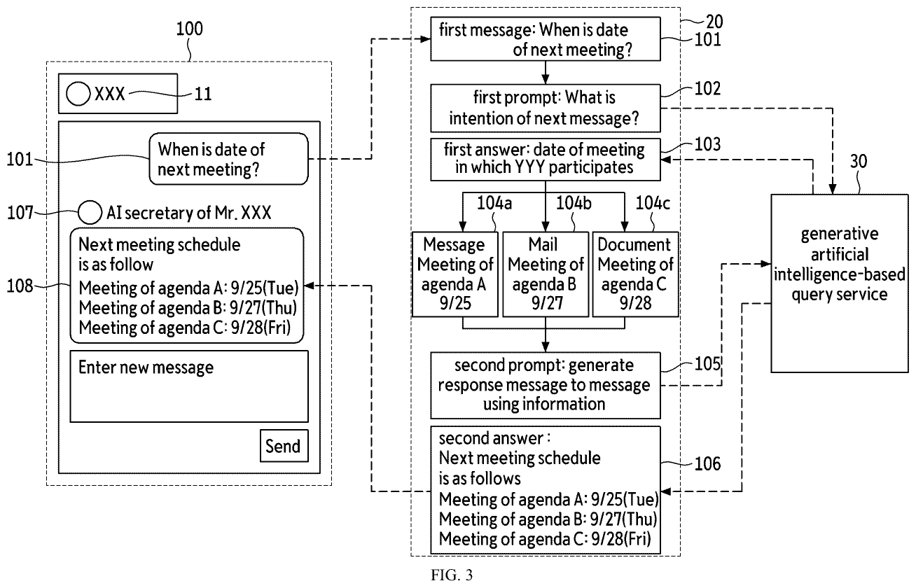

FIG. 2 is an exemplary flow chart illustrating a response generating method, and FIG. 3 is an exemplary view illustrating an example related to the flow chart of FIG. 2.

Referring to FIG. 2, a first message in which a user of an external system is considered as a recipient may be acquired (S100). For example, as shown in FIG. 3, when a message 101 in which a user is considered as a recipient is transmitted from a messenger 100, which is an external system, the first message 101 in which a user is considered as a recipient may be acquired from the messenger 100.

Next, in order to generate a response message using the generative artificial intelligence-based query service 30, a first prompt for identifying an intention of the message may be automatically generated. Also, the first prompt may be transmitted to the generative artificial intelligence-based query service (S200). For example, as shown in FIG. 3, a first prompt 102 related to the first message 101 indicating “When is the date of the next meeting?” may be automatically generated and transmitted to the generative artificial intelligence-based query service 30.

In this case, the intention means a task or purpose related to a task intended to be expressed by the sender through a message. The intention may include a hidden meaning contained in the message or an information request in addition to a content explicitly expressed by the sender. For example, in the message indicating “Hello, when is the meeting today?,” the sender's intention is to ask “the time of the meeting in which the sender participates,” and the response generating system according to some embodiments of the present disclosure may identify the intention to generate an appropriate response.

Next, a first answer generated by the generative artificial intelligence-based query service 30 in response to the transmission of the first prompt may be received (S300). For example, as shown in FIG. 3, a first answer 103 indicating “a date of a meeting in which YYY participates” generated in response to the transmission of the first prompt 102 may be received.

Next, information related to the first answer may be inquired in the internal database that includes first task-related information of a first user (S400). For example, as shown in FIG. 3, the date of the meeting in which YYY participates may be inquired a message 104a, a mail 104b and a document 104c, which are related to the first answer 103.

The task-related information means all data related to task performance between the sender and the user. The task-related information may be used as data necessary for the generative artificial intelligence-based query service to generate an appropriate response. The task-related information exists in various forms such as messages, documents and meeting schedules, and may be inquired or analyzed in the response generating system according to some embodiments of the present disclosure to generate a response.

Next, a second prompt for generating a response message to the first message may be automatically generated using the inquired information, and the second prompt may be transmitted to the generative artificial intelligence-based query service (S500). For example, as shown in FIG. 3, a second prompt 105 may be automatically generated using the date of the meeting in which YYY participates, which is written in the inquired message 104a, mail 104b and document 104c, and may be transmitted to the generative artificial intelligence-based query service 30.

Next, a second answer generated by the generative artificial intelligence-based query service in response to the second prompt may be received (S600). For example, as shown in FIG. 3, a second answer 106 may be received from the artificial intelligence-based query service 30.

Next, a response message to the first message may be generated using the second answer (S700). For example, as shown in FIG. 3, a response message 108 may be generated based on the second answer 106. In addition, the response message 108 may be provided on the messenger 100 together with an indication 107 indicating that the response message 108 is provided by the generative AI model.

When the prompt is automatically generated in the above process, the method of generating the prompt may include all of the case that the prompt is generated based on a rule, the case that the prompt is generated using an artificial intelligence model, and the case that the prompt is generated using a large language model (LLM). In this case, the rule may be a rule set in advance, and the artificial intelligence model may be an independent artificial intelligence model embedded in the AI response management system or distinguished from the AI response management system.

Through these series of processes, the response generating system may accurately identify the intent of the sender's message and quickly provide an optimized response to the sender on behalf of the user. A customized response directly related to the user's task as well as an automated response may be generated by utilizing the information inquired in the internal database. This response generating system enables more efficient and accurate information transfer to the sender on behalf of the user and increases the speed of task processing. In addition, since this response generating method may automatically generate and provide a response message even when the user is absent or busy, continuity and productivity of communication may be greatly improved.

When the response generating system is continuously used, a person who receives the response may feel tired due to repetitive and mechanical responses. In particular, when responses of the same pattern are accumulated, naturalness and human sense of the response may be reduced, whereby user experience may be deteriorated, and a negative influence may be given to reliability and satisfaction of the response. Therefore, in order to solve this problem, AI technology of providing a flexible response customized to the user's situation as well as simply automated answers is required.

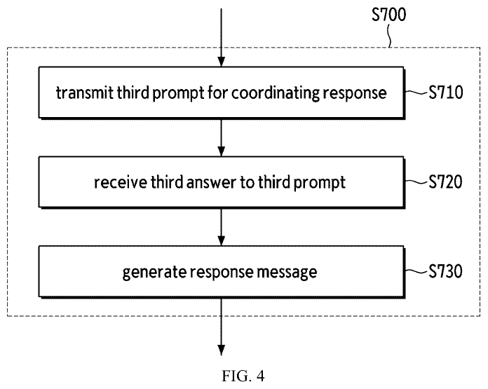

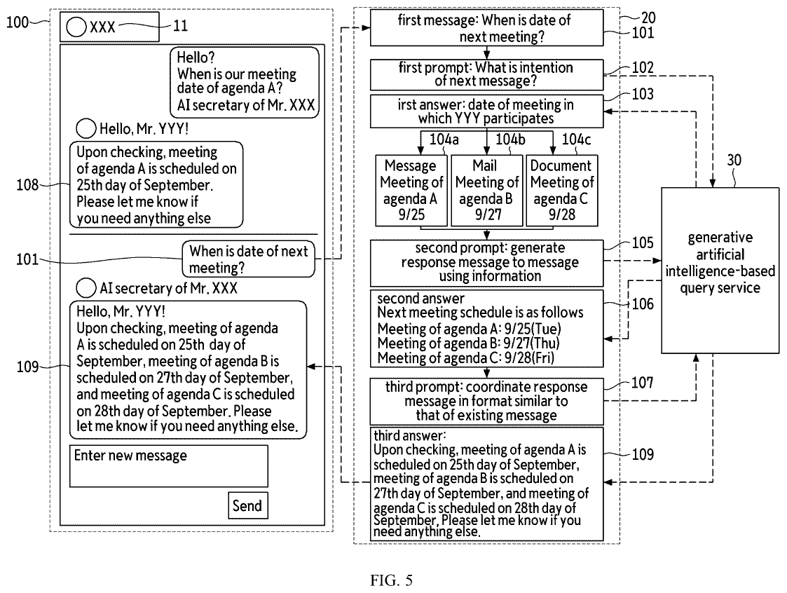

FIG. 4 is a flow chart illustrating a detailed example of S700 of FIG. 2, and FIG. 5 is an exemplary view illustrating a situation of FIG. 4. Hereinafter, a detailed example of S700 will be described with reference to FIGS. 4 and 5. However, only portions different from those of FIG. 2 will be described.

Referring to FIG. 4, the step of generating a response message to the first message may include the following steps.

First, a third prompt for generating a response message to the first message may be automatically generated using the second answer and second task-related information of the first user. In addition, the third prompt may be transmitted to the generative artificial intelligence-based query service 30 (S710).

For example, as shown in FIG. 5, a third prompt 107 for generating a response message may be generated using the second answer 106 generated for the response message to the first message 101 and another message 108 of the user 11 and transmitted to the generative artificial intelligence-based query service 30.

Next, a third answer generated in response to the third prompt may be received (S720), and a response message may be generated using the third answer (S730).

For example, as shown in FIG. 5, the third answer may be received from the generative artificial intelligence-based query service 30. In this case, unlike the second answer 106, the third answer 109 may be generated in a format similar to another message 108 of the user 11.

This response generating method may reduce fatigue caused by responses of the same pattern and maintain continuity and naturalness of communication by accurately utilizing the user's task-related information through the generative AI model. Furthermore, the response generating method may greatly improve efficiency of AI-based communication and user satisfaction by providing a more personalized experience by reflecting a task environment and context in which the user is faced.

When AI automatically generates and provides a message in a state that the user is directly preparing a response, the user's response may be hindered. A situation in which a response intended to be written by the user collides with a content of a response provided by the AI or a duplicate message is delivered to the sender may occur. Such a problem may increase fatigue of the user or the sender, and may deteriorate reliability of the response generating system according to the embodiment of the present disclosure. Accordingly, it is required to provide a technology capable of preventing the collision between the user and the AI.

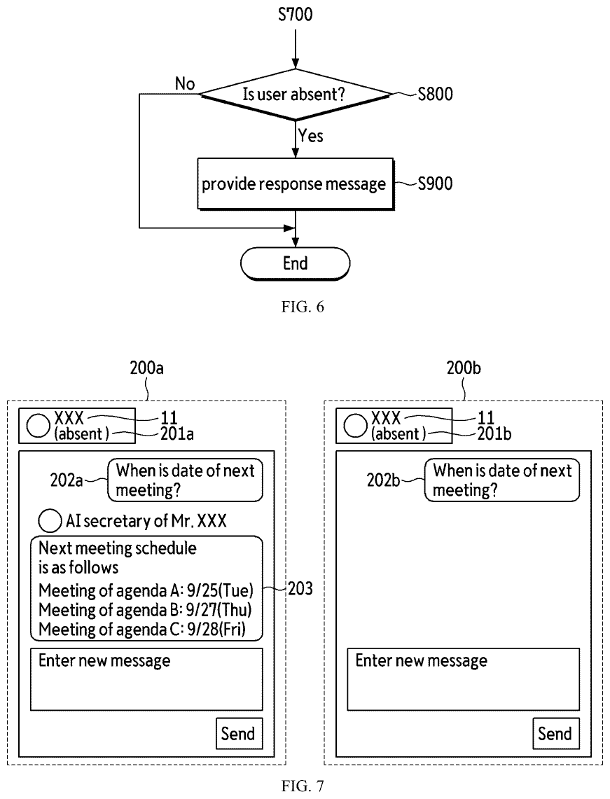

FIG. 6 is an exemplary flow chart illustrating a sequence of a response generating method according to one embodiment of the present disclosure, and FIG. 7 is an exemplary view illustrating a situation of FIG. 6. Hereinafter, a method for providing a response message using a generative AI model only in a user's absent state will be described with reference to FIGS. 6 and 7, but only portions different from those of FIG. 2 will be described.

Referring to FIG. 6, an absent state of a messenger of the first user may be determined (S800). For example, as shown in FIG. 7, when a state of a messenger 200a of the user is displayed as an absent state 201a, the absent state of the messenger of the user 11 may be determined. On the contrary, when a state of a messenger 200b of the user 11 is displayed as a connected state 201b, the absent state of the messenger of the user 11 cannot be determined.

Next, as shown in FIG. 6, the generated response message may be provided to the sender of the first message (S900). The response message may be generated in advance before the absent state of the user 11 is determined, and then the response message may be provided after the absent state of the user 11 is determined. Also, the response message may be generated and provided after the absent state is determined.

For example, as shown in FIG. 7, when the absent state of the messenger 200a is determined, a response message 203 to a message 202a of the sender may be generated and provided. On the contrary, when an absent state of a messenger 100b is not determined, a response message to a message 202b of the sender may not be provided.

The AI may be controlled through this response generating method, so that the AI does not intervene in a situation that the user may directly respond. That is, the user directly leads communication when the user is connected, and the AI automatically manages messages only when the user is absent, whereby collision between the AI and the user may be minimized.

There may be a case in which the user is temporarily unable to respond to the sender's message even though the user is in the connected state. For example, when the user is in a meeting or is concentrating on an important task, a situation in which the user may not respond to the sender's request immediately may occur. Therefore, it is required to provide a technology of generating and providing a response message by determining a time point when AI intervention is required even though the user is not in the absent state.

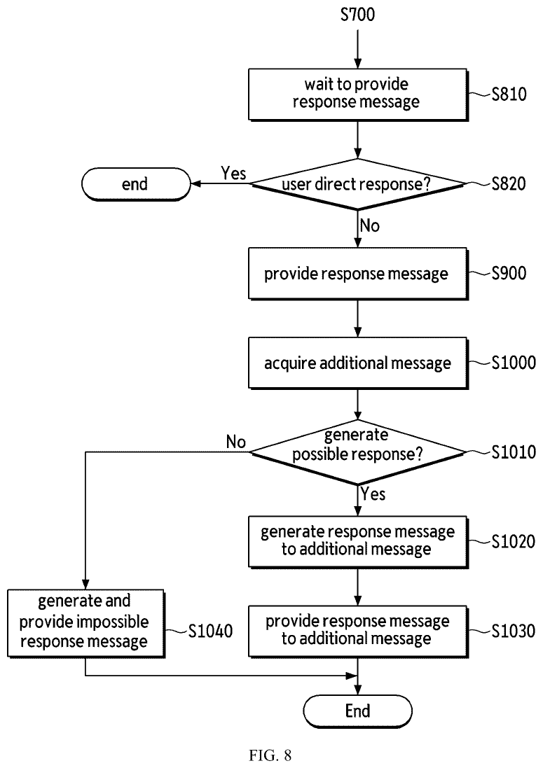

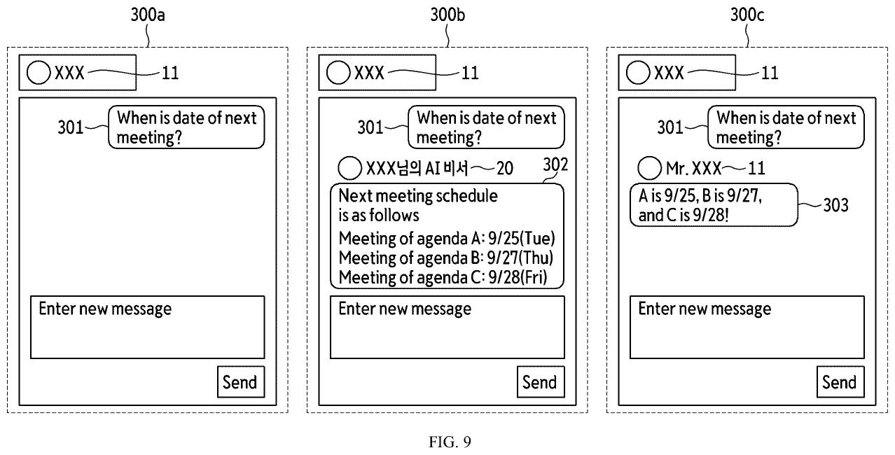

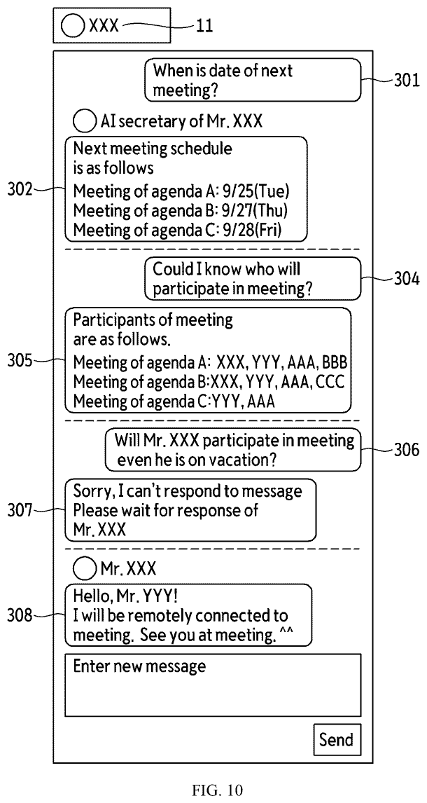

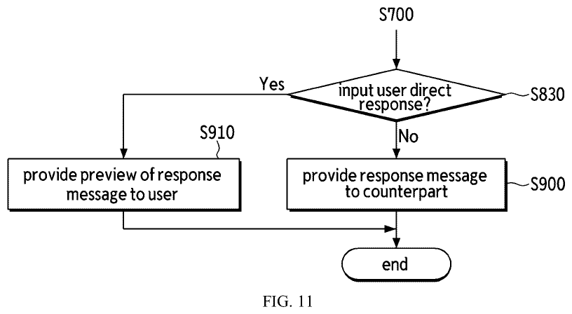

FIG. 8 is an exemplary flow chart illustrating a sequence of a response generating method according to one embodiment of the present disclosure, and FIGS. 9 and 10 are exemplary views illustrating a situation of FIG. 8. Hereinafter, a method for providing a response message using a generative AI model without collision with a user even when the user is not in an absent state will be described with reference to FIGS. 8 to 10, but only portions different from those of FIG. 2 will be described.

Referring to FIG. 8, for a preset time, a response message to the first message of the first user may wait to be provided (S810).

For example, as shown in FIG. 9, when a message 301 is provided from a sender on a messenger 300a, a response message to the message 301 of the user 11 may wait to be provided for a preset time. In this case, the preset time may mean the time required for the user 11 to input and provide the response message.

Next, it may be determined whether the first user directly provides the response message to the first message for the preset time (S820).

Subsequently, when the first user does not provide the response message to the first message, the response message to the generated first message may be provided to the sender of the first message (S900).

For example, as shown in FIG. 9, on a messenger 300b, when it is determined that the user 11 has not provided a response message to the message 301 for the preset time, a response message 302 generated by the AI response management system 20 may be provided.

On the contrary, on a messenger 300c, when it is determined that the user 11 has provided a response message 303 to the message 301 for a preset time, the response message generated by the AI response management system 20 may not be provided.

In this case, when the message of the sender is provided, a response message may be generated immediately. Afterwards, the response message may wait to be provided for a preset time. Also, when the message of the sender is provided, a response message may be generated and provided to the sender after the preset time has elapsed.

Next, a second message may be additionally received from the sender of the first message (S1000), and it may be determined whether or not it is possible to generate a response message to the second message (S1010).

Subsequently, when it is possible to generate the response message to the second message, the response message to the second message may be generated (S1020), and the response message to the second message may be provided to the sender of the first message without waiting as soon as the response message is generated (S1030).

For example, as shown in FIG. 10, a first message 301 for a query of a meeting date may be acquired. Also, since there is no response from the user 11 for a preset time, a response message 302 to the first message may be generated and provided to the sender. Afterwards, a second message 304 containing a content of meeting participants may be acquired from the sender of the first message 301. In addition, it is determined whether or not it is possible to generate a response message to the second message 304, and a response message 305 to the second message 304 may be provided immediately without waiting for a preset time.

The second message may mean a message acquired from the same sender after the AI response management system 20 provides a response message to the first message. The second message is not limited to a message acquired immediately after the first message. For example, as shown in FIG. 10, both the message 304 and the message 306 may be included in the second message.

The response message to the second message may be generated in the same method as the method illustrated in FIG. 2, or may be generated in a different method from the method illustrated in FIG. 2.

Referring back to FIG. 8, when it is impossible to generate a response message to the second message, a message indicating that it is impossible to generate a response message to the second message may be immediately provided to the sender of the first message (S1040).

For example, as shown in FIG. 10, another message 306 as to whether the user 11 on vacation participates in the meeting may be provided from the sender of the first message 301. Subsequently, it may be determined whether or not it is possible to generate a response message to another message 306. Whether the user 11 on vacation participates in the meeting needs a detailed determination of the user 11, and thus it may be determined that the response message cannot be generated. Since the response message cannot be generated, a message 307 indicating that the response message cannot be generated may be generated and provided to the sender. A response message 308 to the message 306 may be provided directly from the user 11 later.

Through this response generating method, even when the user is not in the absent state, collision between the user and the AI may be prevented. Also, the AI may immediately respond to additional message so that delay for the sender's request may be minimized. Also, when a response to additional message is not possible, a state in which a response to additional message is not possible may be immediately notified to enable efficient communication.

There may be a case in which the AI response management system 20 provides a response message because the user is writing a response message with a large amount of content and thus does not provide the response message for a preset time. In this case, it is required to provide a technology of preventing collision between the user and the AI.

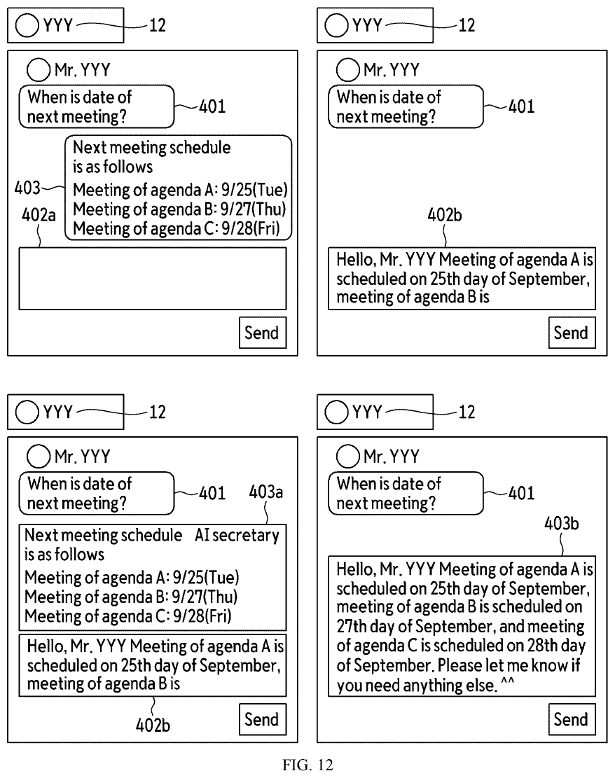

FIG. 11 is a flow chart illustrating a response generating method according to one embodiment of the present disclosure, and FIG. 12 is an exemplary view illustrating a situation of FIG. 11. Hereinafter, a method for preventing a collision between an AI and a user when the user is inputting a response message will be described with reference to FIGS. 11 and 12.

Referring to FIG. 11, an input of a response message to the first message of the user may be sensed (S830). In addition, when the input of the response message is not sensed, the generated response message may be provided to a counterpart of the messenger (S900).

For example, as shown in FIG. 12, a first message 401 may be provided, and whether the user 11 directly inputs a response message to the first message into an input window 402a may be sensed. When the input of the response message is not sensed because the response message is not input into the input window 402a, a response message 403 may be generated and provided to the sender.

On the contrary, as shown in FIG. 12, when the user 11 is inputting the response message to the first message 401 into the input window 402b, the response message 403 generated by the response generating system may not be provided.

Referring back to FIG. 11, when the input of the response message is sensed, the response generating system may display a preview of the generated response message to the first user (S910).

The preview of the message means that the message generated by the response generating system is not provided but is temporarily displayed on the external system so that only the user can see it. For example, when a response message generated by AI is temporarily displayed on the input window of the messenger and the user can check it, it may be considered that the preview of the message is displayed.

As a detailed example, as shown in FIG. 12, the user 11 may input the response message to the first message 401 into the input window 402b of the messenger. In this case, the response message to the first message 401, which is generated in advance by the AI management system 20, may be displayed as a preview only to the user 11, not the sender.

The preview may be displayed on the input window 402b in the form of a pop-up window like 403a, which can be temporarily checked. Also, the preview is displayed in the input window 402b as a phrase connected to the response message being input by the user 11 like 403b, but its color, font, size, etc. may be changed to be distinguished from the response message being input by the user 11.

Through this response generating method, the user may maintain a natural conversation flow, and collision between the user and the AI may be prevented even when the user is not in the absent state and does not provide a message for a preset time. Also, the preview may be provided to the user, so that the user may receive an opportunity to review the response of the AI and modify or improve the response message as needed. That is, it is possible to increase the accuracy and appropriateness of the user's response message.

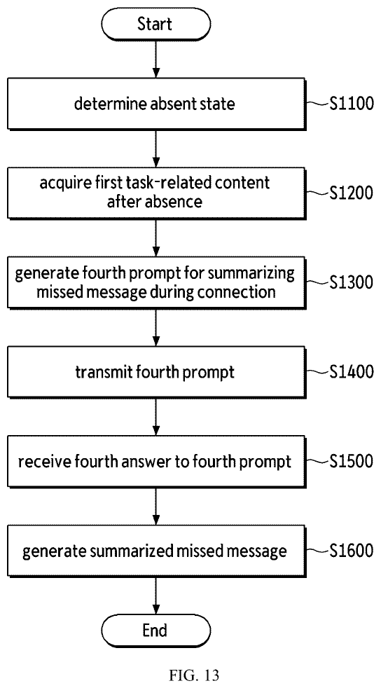

The task-related content acquired by the AI response management system 20 during the user's absent state may be utilized when the user's state is changed to the connected state. In detail, the response generating system may generate a response message (hereinafter, referred to as a summarized missed message) that summarizes the task-related content acquired during the user's absent state to the user. Hereinafter, a method for generating a summarized missed message using a generative AI model according to one embodiment of the present disclosure will be described with reference to FIGS. 13 to 18.

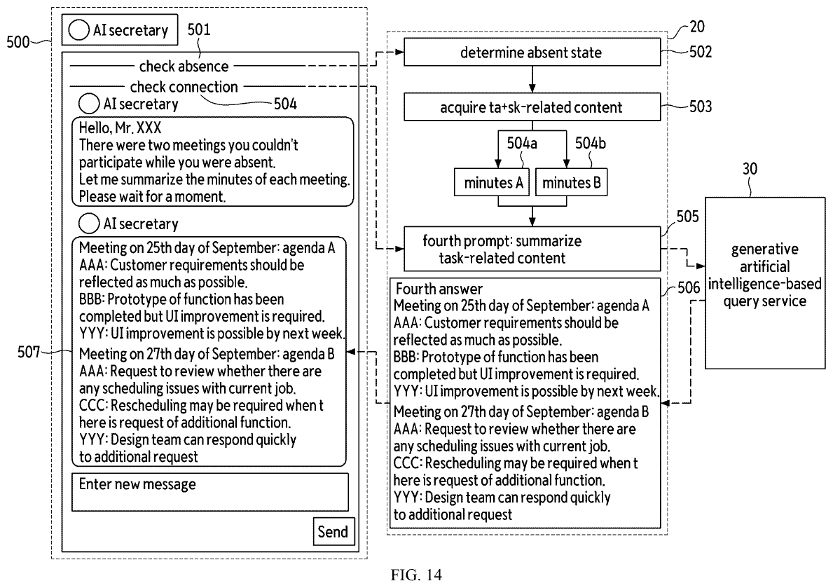

FIG. 13 is a flow chart illustrating a method for generating a summarized missed message using a generative AI model according to one embodiment of the present disclosure, and FIG. 14 is an exemplary view illustrating a situation of FIG. 13.

Referring to FIG. 13, the response generating method of the present disclosure may include the following steps.

The absent state of the messenger of the first user may be determined (S1100). For example, as shown in FIG. 14, the absent state of the user 11 may be checked (501) in a messenger 500 that is an external system. When the absent state of the user 11 is checked in the messenger, the absent state of the user 11 may be determined (502).

Next, the first task-related content related to the first user and generated after a time point when the absent state of the first user is determined may be acquired (S1200).

For example, as shown in FIG. 14, the task-related content may be acquired (503) after the absent state is determined. The task-related content 503 may include minutes 503a of a meeting of agenda A and minutes 503b of a meeting of agenda B, which are held while the user 11 is absent due to vacation.

Next, when the state of the messenger of the first user is changed to the connected state, a fourth prompt for summarizing the acquired task-related content may be automatically generated (S1300).

For example, as shown in FIG. 14, the change of the state of the user 11 from the absent state to the connected state may be checked (504) in the messenger 500. When the change to the connected state is checked (504), a fourth prompt 505 for summarizing contents of the minutes 503a of the meeting of agenda A and the minutes 503b of the meeting of agenda B, which are acquired after the determination of the absent state, may be automatically generated.

Next, the fourth prompt may be transmitted to the generative artificial intelligence-based query service (S1400). Subsequently, a fourth answer may be received from the generative artificial intelligence-based query service in response to the transmission of the fourth prompt (S1500).

Next, the summarized missed message may be generated using the received fourth answer (S1600). For example, as shown in FIG. 14, the fourth prompt 505 may be transmitted to the generative artificial intelligence-based query service 30, and the generative artificial intelligence-based query service 30 may receive a fourth answer 506 in response to the transmission of the fourth prompt. The fourth answer 506 may be a message summarizing the minutes 503a of the meeting of agenda A and the minutes 503b of the meeting of agenda B. Subsequently, a summarized missed message 507 may be generated using the fourth answer 506, and the summarized missed message 507 may be provided to the user 11 of the messenger 500.

Through the method for generating a summarized missed message using a generative AI model, the user may identify key information at once through the summarized message after returning to task without having to check a large amount of task information one by one, which occurs when the user is absent. That is, the time required to search for information may be greatly reduced, and the user may resume task more quickly. In addition, it is possible to prevent a situation in which a user accidentally misses an important mail or document.

Since the summarized missed message provides a concise summary of important information, it does not include all details and it may be difficult for the user to identify all the details. Due to this limitation, the user may have difficulty in making specific decisions or understanding details with only the summarized information. Therefore, a technology capable of quickly identifying necessary information through a summary message and then selectively checking details intended to know in more detail is required.

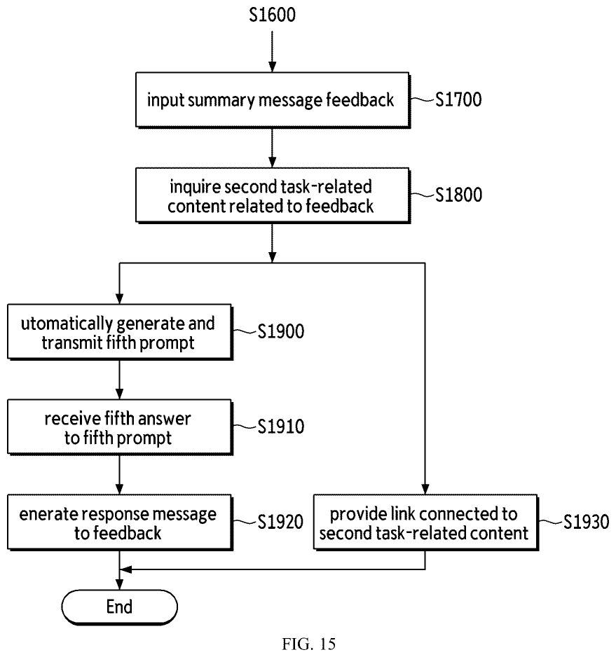

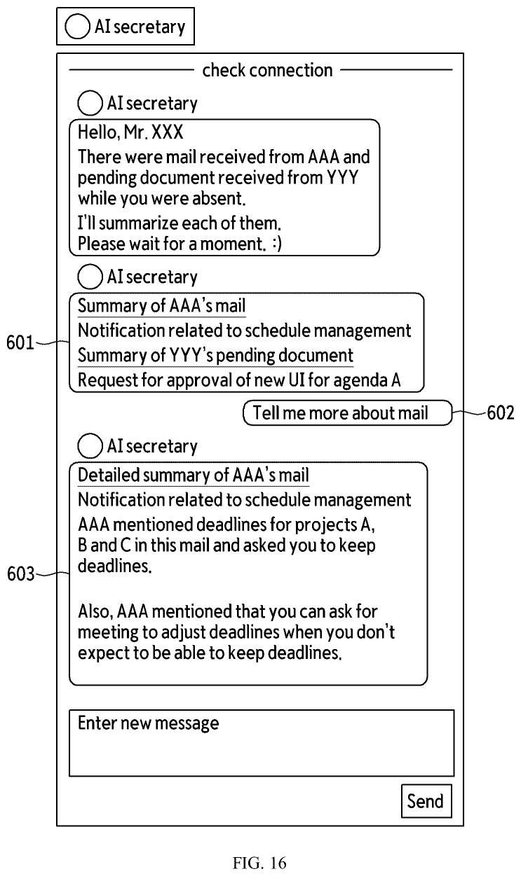

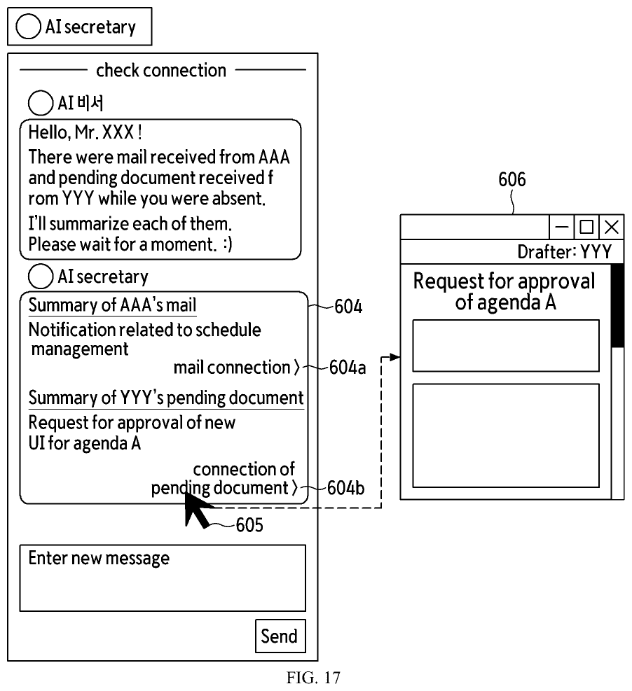

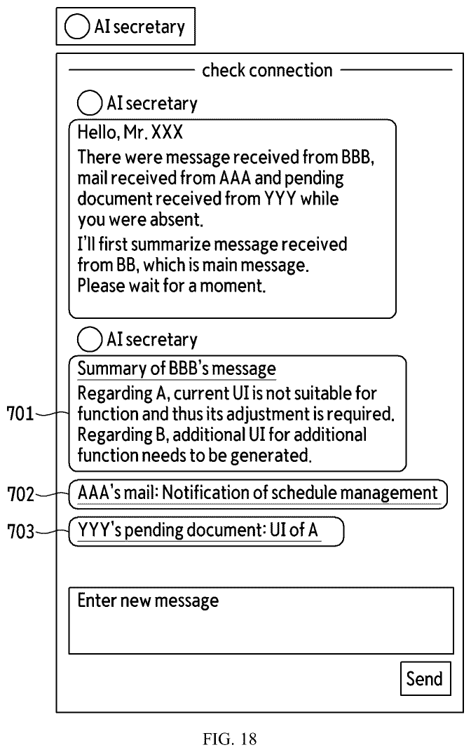

FIG. 15 is a flow chart illustrating a method for generating a summarized missed message using a generative AI model according to one embodiment of the present disclosure, and FIGS. 16 and 17 are exemplary views illustrating a situation of FIG. 15. Hereinafter, a method for generating a summarized missed message using a generative AI model capable of checking details of a summary message through a feedback of the summary message will be described with reference to FIGS. 15 to 17.

Referring to FIG. 15, a method for generating a summarized missed message using a generative AI model (hereinafter, a summarized missed message generating method) according to one embodiment of the present disclosure may further include the following steps.

First, a feedback related to the summarized missed message may be input from the first user (S1700). For example, as shown in FIG. 16, when the user 11 provides a message 602 indicating “tell me more about mail” with respect to a summarized missed message 601 provided by the AI response management system 20, it may be considered that a feedback related to the summarized missed message 601 has been input.

Also, as shown in FIG. 17, for a summarized missed message 604 provided by the AI response management system 20, when the user 11 taps/clicks (605) a link connected to the external system, it may be considered that a feedback related to the summarized missed message 604 has been input.

Next, information related to the feedback may be inquired in the internal database that includes the second task-related content of the first user (S1800). For example, as shown in FIG. 16, ‘AAA's mail’ written in the message 602 may be inquired in the internal database. In addition, as shown in FIG. 17, ‘YYY's pending document’ which is tapped/clicked (605) may be inquired in the internal database.

Next, a fifth prompt for generating an answer to the feedback may be automatically generated using the inquired second task-related content. Also, the fifth prompt may be transmitted to the generative artificial intelligence-based query service (S1900).

For example, as shown in FIG. 16, a prompt (e.g., a detailed summary for only the mentioned task-related content) for generating a summary message 603 for the feedback may be automatically generated, and the prompt may be transmitted to the generative artificial intelligence-based query service 30.

Next, a fifth answer responded to the transmission of the fifth prompt may be received from the generative artificial intelligence-based query service (S1910). Also, a response message to the feedback may be generated using the received fifth answer (S1920).

For example, as shown in FIG. 16, the generative artificial intelligence-based query service generates an answer in response to the prompt (e.g., the detailed summary for only the mentioned task-related content), and the response message 603 to the feedback may be generated using the answer, and may be provided to the user.

Referring back to FIG. 15, a method for generating a missed message may include a step S1930 in which a link connected to the inquired second task-related content is provided to the first user.

For example, as shown in FIG. 17, links 604a and 604b linked to the task-related content mentioned in the summarized missed message may be provided to the user 11 (604).

As a detailed example, the links 604a and 604b connected to a mail and a pending document may be provided along with the summarized missed message 604, and the link 604b connected to the pending document may be connected to the pending document 606 when tapped/clicked.

Through this method for generating a summarized missed message, the user may first respond to a core task even without checking all unnecessary information. That is, this method may greatly improve task efficiency and productivity by preventing user information overload from occurring and preventing an important task from being delayed.

When there are excessively many task-related contents generated when the user is absent, checking summary messages for all contents is not only inefficient, but also may burden the user's task processing. In particular, there may be a situation in which urgent or important task-related contents are missed due to multiple summary messages. Therefore, it is required to provide a technology of selecting a task which is urgent or should be preferentially processed and supporting a user to first check the task.

FIG. 18 is an exemplary view illustrating a method for generating a summarized missed message using a generative AI model according to one embodiment of the present disclosure.

In one embodiment, a priority for the first task-related content set in advance may be checked. Next, a summarized missed message for the task-related content having the checked priority may be provided to the first user.

As a detailed example, the priority may be set based on a sender of a task-related content. When the sender is BBB, the priority may be set, and when the sender is not BBB, the priority may not be set. Afterwards, the pre-set priority may be confirmed. As shown in FIG. 18, a summarized missed message 701 of the ‘message received from BBB’ in which the priority is set may be summarized in detail and provided to the user 11.

As shown in FIG. 18, details of a summarized missed message 702 of the ‘mail received from AAA’ with no priority set and a summarized missed message 703 of the ‘pending document received from YYY’ are not displayed, but the messages 702 and 703 may be briefly summarized only for their titles, and may be provided to the user 11.

The priority in the present disclosure means a priority set for a task-related content to which the response generating system is preferentially applied. As the priority is higher, the corresponding content may be displayed in more detail or processed first. The priority may be a priority for the sender (e.g., manager, client, or team member) or a priority for a type of task-related content (e.g., minutes, mail, or message), and may be set for a specific task or agenda (e.g., agenda A, agenda B or agenda C). The priority may be set by the user, and may be set based on a rule.

Through this method for generating a summarized missed message, since the user may efficiently manage a priority of task and immediately respond to an important task without wasting time on unnecessary information, efficiency of the users' task processing may be improved.

The response generating method and system have been described. The generative artificial intelligence-based query service mentioned in the above description may be the same service for each prompt, or may be a different service for each prompt.

When the same artificial intelligence-based query service is used for each prompt, consistency in quality of the answers received from the artificial intelligence-based query service may be maintained. Also, it is possible to generate efficient answers by fine-tuning the artificial intelligence-based query service based on task-related content/information. Also, since previous answers may be easily tracked and linked, the system may be managed in an integrated manner without the need to collect data for each prompt.

When a different artificial intelligence-based query service is used for each prompt, a more specialized answer may be provided. For example, when the intent of the sender's message is identified, an artificial intelligence-based query service with excellent inference ability may be used, and when a response message is generated based on task-related information, an artificial intelligence-based query service with excellent expression ability may be used. Also, when a problem occurs or performance degradation occurs in a specific artificial intelligence-based query service, another artificial intelligence-based query service may be used to reduce dependence on one service and disperse risks.

In the above description, the external system has been described to be limited only to the messenger for convenience of description, but it should be noted that the external system may include another system other than the messenger. For example, the external system may be a mail system. When sending a mail to the user as a recipient, the AI response management system may identify the intention of the message in the mail, automatically generate a prompt for generating a response message to the message in the mail, transmit the prompt to the artificial intelligence-based query service and generate a response message by using the answer received from the artificial intelligence-based query service. Also, the AI response management system may generate the mail including the generated response message in connection with the mail system that is the external system, and may transmit the generated mail to the sender. In addition, the external system may include a document program, a video conference program, and the like.

In the above description, the feedback for the summarized missed message has been described by message and tap/click for convenience of description, but it should be noted that the feedback for the summarized missed message is not limited to this example.

The response generating method and system may automate and efficiently manage communication between the user and the sender. The AI may identify the intent of the sender's message and generate a customized response based on the user's task-related information to increase the speed and accuracy of communication. In particular, the AI may automatically process important messages or urgent tasks even when the user is absent, and may provide summarized information to support a quick response after the user returns to task.

Also, since the AI processes the response on behalf of the user, it is possible to reduce the user's task burden, minimize fatigue of the user or the sender due to repetitive responses, and maximize efficiency and productivity of the system.

Also, in a situation that the user may directly respond to the message of the sender, the AI may wait without automatically responding to the message of the sender, thereby avoiding collision of duplicate messages or contents. In addition, only when the user does not respond for a certain period of time, the AI provides a response instead, thereby minimizing unnecessary intervention and naturally maintaining the flow of communication. In addition, a response generated by the AI is provided in the form of preview, so that the user may modify the response after reviewing it or select the response, thereby providing flexibility for the AI and the user to coordinate communication cooperatively.

In addition, it is possible to safely store and manage the user's task-related information by using the internal database, and reduce the risk of information leakage by minimizing unnecessary data exchange with the external system. Also, the internal database may apply security policies internally, and thus may make it possible to process sensitive information or confidential data more safely. The response generating method and system may make sure of integrity and confidentiality of the user's task-related information, and may safely process communication in an environment protected from external threats.

The effects according to the technical spirits of the present disclosure are not limited to those mentioned above, and other effects that are not mentioned above will be clearly understood by those skilled in the art from the content of the present disclosure.

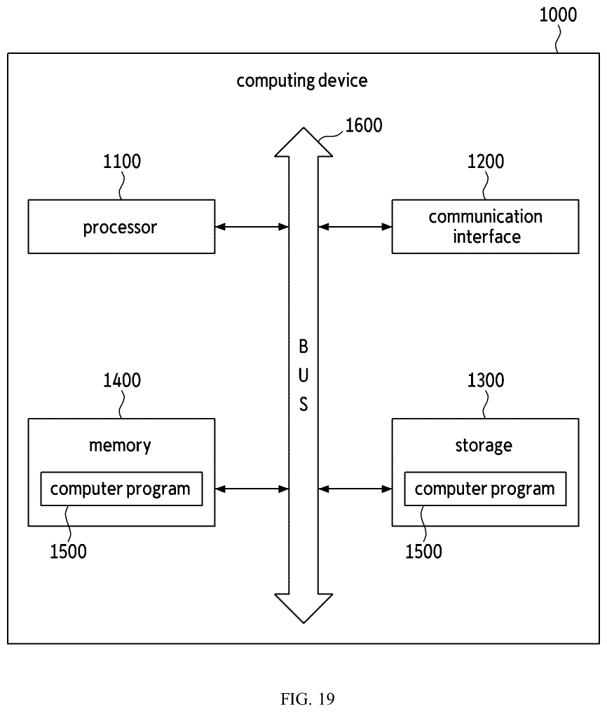

Hereinafter, a hardware configuration of an exemplary computing device according to some embodiments of the present disclosure will be described with reference to FIG. 19. The computing device may be a computing device in which an external system is operated, a computing device in which an AI response management system is operated, or a computing device in which a generative artificial intelligence-based query service is operated.

FIG. 19 is an exemplary hardware schematic diagram illustrating that a computing device may be implemented in various embodiments of the present disclosure. A computing device 1000 may include one or more processors 1100, a system bus 1600, a communication interface 1200, a memory 1400 for loading a computer program 1500 performed by the processor 1100, and a storage 1300 for storing the computer program 1500. In FIG. 20, only components related to the embodiments of the present disclosure are shown. Accordingly, it may be apparent to those skilled in the art that other general components in addition to the components shown in FIG. 19 may be further included in the computing device.

The processor 1100 may control the overall operation of each component of the computing device 1000. The processor 1100 may be configured to include at least one of a Central Processing Unit (CPU), a Micro Processor Unit (MPU), a Micro Controller Unit (MCU), a Graphic Processing Unit (GPU), or any type of processor well known in the art of the present disclosure. In addition, the processor 1100 may perform computation for at least one application or program for executing operations/methods according to various embodiments of the present disclosure. The computing device 1000 may include two or more processors.

The memory 1400 may store various types of contents, commands and/or information. The memory 1400 may load one or more programs 1500 from the storage 1300 to execute the operations/methods according to the embodiments of the present disclosure. An example of the memory 1400 may be a RAM, but is not limited thereto. The system bus 1600 provides a communication function between components of the computing device 1000.

The system bus 1600 may be implemented as various types of buses such as an address bus, a content bus, and a control bus. The communication interface 1200 supports wired/wireless Internet communication of the computing device 1000. The communication interface 1200 may support various communication methods other than Internet communication. To this end, the communication interface 1200 may be configured to include a communication module well known in the art of the present disclosure. The storage 1300 may non-temporarily store one or more computer programs 1500. The storage 1300 may include a nonvolatile memory such as a flash memory, a hard disk, a detachable disk, or any type of computer-readable recording medium well known in the art to which the present disclosure pertains.

The computer program 1500 may include one or more instructions in which the methods/operations according to various embodiments of the present disclosure are implemented. When the computer program 1500 is loaded into the memory 1400, the processor 1100 may perform the methods/operations according to various embodiments of the present disclosure by executing the one or more instructions.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation. The scope of protection of the present invention should be interpreted in accordance with the claims below, and all technical ideas within the equivalent scope should be construed as being included in the scope of rights of the technical ideas defined by this disclosure.

What is claimed is:

1. A method for generating a response message using a generative AI model, performed by a computing system, the method comprising:
acquiring a first message with a first user as a recipient;
automatically generating a first prompt for identifying an intention of the first message and transmitting the first prompt to a generative artificial intelligence-based query service;
receiving a first answer from the generative artificial intelligence-based query service in response to the transmission of the first prompt;
inquiring information related to the first answer in an internal database that includes first task-related information of the first user;
automatically generating a second prompt for generating a response to the first message by using the inquired first task-related information and transmitting the second prompt to the generative artificial intelligence-based query service; and
generating a response message to the first message by using a second answer received from the generative artificial intelligence-based query service in response to the transmission of the second prompt.

2. The method of claim 1, wherein the generating the response message to the first message includes:
automatically generating a third prompt for generating the response message to the first message by using the second answer and second task-related information of the first user and transmitting the third prompt to the generative artificial intelligence-based query service; and
generating the response message to the first message by using a third answer received from the generative artificial intelligence-based query service in response to the transmission of the third prompt.

3. The method of claim 1, further comprising:
determining an absent state of a messenger of the first user; and
providing the generated response message to a sender of the first message.

4. The method of claim 1, further comprising:
waiting for the first user to provide the response message to the first message for a preset time; and
providing the generated response message to the first message to a sender of the first message when the first user does not provide the response message to the first message for the preset time.

5. The method of claim 4, further comprising:
additionally receiving a second message from the sender of the first message;
generating a response message to the second message; and
immediately providing the response message to the second message to the sender of the first message.

6. The method of claim 4, further comprising:
additionally receiving a second message from the sender of the first message;
determining whether it is possible to generate a response message to the second message; and
immediately providing a message, which indicates that it is not possible to generate the response message to the second message, to the sender of the first message when it is not possible to generate the response message to the second message.

7. The method of claim 1, further comprising:
sensing an input of the response message to the first message of the first user; and
providing the generated response message to a sender of the first message when the input of the response message is not sensed.

8. The method of claim 1, further comprising:
sensing an input of the response message to the first message of the first user; and
displaying a preview of the generated response message to the first user when the input of the response message is sensed.

9. A method for generating a response message using a generative AI model, performed by a computing system, the method comprising:
determining an absent state of a messenger of a first user;
acquiring a first task-related content related to the first user and generated after a time when the absent state of the first user is determined;
automatically generating a fourth prompt for summarizing the acquired task-related content when the messenger of the first user is changed to a connected state;
transmitting the fourth prompt to a generative artificial intelligence-based query service; and
generating a summarized missed message by using a fourth answer received from the generative artificial intelligence-based query service in response to the transmission of the fourth prompt.

10. The method of claim 9, further comprising:
receiving a feedback related to the summarized missed message from the first user;
inquiring information related to the feedback in an internal database that includes a second task-related content of the first user;
automatically generating a fifth prompt for generating an answer to the feedback by using the inquired second task-related content and transmitting the fifth prompt to the generative artificial intelligence-based query service; and
generating a response message to the feedback by using a fifth answer received from the generative artificial intelligence-based query service in response to the transmission of the fifth prompt.

11. The method of claim 9, further comprising:
receiving a feedback related to the summarized missed message from the first user;
inquiring information related to the feedback in an internal database that includes a second task-related content of the first user; and
providing the first user with a link connected to the inquired second task-related content.

12. The method of claim 9, further comprising:
checking a priority for the first task-related content set in advance; and
providing the first user with a summarized missed message for the task-related content of which priority has been checked.

13. A system for generating a response message using a generative AI model, the system comprising:
a communication interface;
a memory into which a computer program is loaded; and
one or more processors in which the computer program is executed,
wherein the computer program includes:
an operation of acquiring a first message with a first user as a recipient;
an operation of automatically generating a first prompt for identifying an intention of the first message and transmitting the first prompt to a generative artificial intelligence-based query service;
an operation of receiving a first answer from the generative artificial intelligence-based query service in response to the transmission of the first prompt;
an operation of inquiring information related to the first answer in an internal database that includes first task-related information of the first user;
an operation of automatically generating a second prompt for generating an answer to the first message by using the inquired first task-related information and transmitting the first prompt to the generative artificial intelligence-based query service; and
an operation of generating a response message to the first message by using a second answer received from the generative artificial intelligence-based query service in response to the transmission of the second prompt.

14. The system of claim 13, wherein the computer program further includes:
an operation of automatically generating a third prompt for generating the response message to the first message by using the second answer and second task-related information of the first user and transmitting the third prompt to the generative artificial intelligence-based query service; and
an operation of generating the response message to the first message by using a third answer received from the generative artificial intelligence-based query service in response to the transmission of the third prompt.

15. The system of claim 13, wherein the computer program further includes:
an operation of determining an absent state of a messenger of the first user; and
an operation of providing the generated response message to the first message to a counterpart of the messenger.

16. The system of claim 13, wherein the computer program further includes:
an operation of waiting for the first user to provide the response message to the first message for a preset time; and
an operation of providing the generated response message to the first message to a sender of the first message when the first user does not provide the response message to the first message for the preset time.

17. The system of claim 13, wherein the computer program further includes:
an operation of sensing an input of the response message to the first message of the first user; and
providing the generated response message to a sender of the first message when the input of the response message is not sensed.
